(19) United States
(12) Patent Application Publication
(10) Pub. No.: US 2008/0002826 A1
(43) Pub. Date: Jan. 3, 2008

(54) Copyright protection system, copyright protection device and video processing apparatus

(75) Inventors: Midori Nakamae, Ome-shi (JP); Koji Kanazawa, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/812,597

(22) Filed: Jun. 20, 2007

(30) Foreign Application Priority Data
Jun. 23, 2006 (JP) 2006-173923

(51) Int. Cl. H04N 7/167; H04L 9/28

(52) U.S. Cl. 380/201; 380/28

(57) ABSTRACT

According to one embodiment, a copyright protection system includes a copyright protection device which encrypts the data for transferring to a processor via a bus and includes a copyright protection device nonvolatile memory which stores an encryption key parameter to be a source of an encryption key to be used for the encryption by the protection device, a nonvolatile memory which is connected to the protection device via the bus and stores the encryption key parameter stored in the copyright protection device nonvolatile memory, and a decryption unit which is composed of software to be executed by the processor. The decryption unit generates the encryption key on the basis of the encryption key parameter stored in the copyright protection device nonvolatile memory and makes the processor execute processing to decrypt the encrypted data, transferred from the protection device via the bus, by using the generated encryption key.

### CROSS-REFERENCE TO RELATED APPLICATIONS

This application is based upon and claims the benefit of priority from Japanese Patent Applications No. 2006-173923, filed Jun. 23, 2006 the entire contents of which are incorporated herein by reference.

### BACKGROUND

1. Field

One embodiment of the present invention relates to a copyright protection system including a copyright protection device to apply encryption to data in need of copyright protection and a decryption unit to decrypt the encrypted data, to a copyright protection device to be used for such a copyright protection system, and to a video processing apparatus that is such a copyright protection system in the case that the data in need of the copyright protection is video data.

2. Description of the Related Art

For example, Jpn. Pat. Appln. KOKAI Publication No. 2002-14818 discloses an information processing apparatus equipped with a first copying unit in which a BIOS copies a BIOS setting parameter stored in a CMOS to a flash memory, and with a second copying unit in which the BIOS copies the BIOS setting parameter stored in the flash memory to the CMOS.

To prevent illegal analysis, a copyright protection system needs to encrypt output data on a bus (hereinafter, referred to as user access bus), to which a third party can access in use of a general-purpose tool, by a copyright protection device. The encrypted data is decrypted into a plain text by decryption through a control device composing a decryption unit and put it to use.

An encryption key to be used for the encryption is generated on the basis of the encryption key parameter, and the key parameter is usually stored in an EEPROM, etc., on the copyright protection device.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram of an information processing apparatus, such as a personal computer, to which a copyright protection system according to an embodiment of the invention is applied;

FIG. 2 is an exemplary block diagram of a copyright protection device according to the embodiment of the invention;

FIG. 3 is an exemplary diagram showing an illustrative configuration of a parameter encryption key table in the copyright protection device in FIG. 2;

FIG. 4 is an exemplary diagram showing an illustrative configuration of a parameter table managed by the copyright protection device in FIG. 2;

FIG. 5 is an exemplary diagram showing an illustrative configuration of a parameter table managed by a control device in FIG. 1;

FIG. 6 is an exemplary flowchart of an entire operation of the information processing apparatus in FIG. 1;

FIG. 7 is an exemplary flowchart of a system start processing in FIG. 6;

FIG. 8 is an exemplary diagram for explaining an example of update, by the system start processing, of a parameter table managed by the control device in an initial state;

FIG. 9 is an exemplary flowchart of command processing in FIG. 6;

FIG. 10 is an exemplary diagram showing an illustrative configuration of an updated parameter table managed by the copyright protection device after MOVE processing in FIG. 9;

FIG. 11 is an exemplary diagram showing an illustrative configuration of an updated parameter table managed by the control device after the MOVE processing in FIG. 9;

FIG. 12 is an exemplary diagram for explaining an example in which a faulty copyright protection device is replaced with a new copyright protection device;

FIG. 13 is an exemplary diagram for explaining an example of update of a parameter table managed by the new copyright protection device resulting from the replacement of the copyright protection device;

FIG. 14 is an exemplary diagram for explaining an example in which a faulty control device is replaced with a new control device; and

FIG. 15 is an exemplary diagram for explaining an example of update of the parameter table managed by the new control device resulting from the replacement of the control device.

### DETAILED DESCRIPTION

Various embodiments according to the invention will be described hereinafter with reference to the accompanying drawings. In general, according to one embodiment of the invention, a copyright protection system includes a processor configured to execute a variety of programs, a bus which transfers a variety of items of data, and a copyright protection device which encrypts the data for transferring the data in need of copyright protection to the processor via the bus. In the copyright protection device, a copyright protection device nonvolatile memory which stores, in non-volatile form, an encryption key parameter to be a source of an encryption key to be used for a encryption by the copyright protection device. The copyright protection system further includes a nonvolatile memory which is connected to the copyright protection device via the bus and stores, in non-volatile form, the encryption key parameter stored in the copyright protection device nonvolatile memory, and a decryption unit which is composed of software to be executed by the processor. The decryption unit generates the encryption key on the basis of the encryption key parameter stored in the copyright protection device nonvolatile memory and makes the processor execute processing to decrypt the encrypted data, which is transferred from the copyright protection device via the bus, by using the generated encryption key.

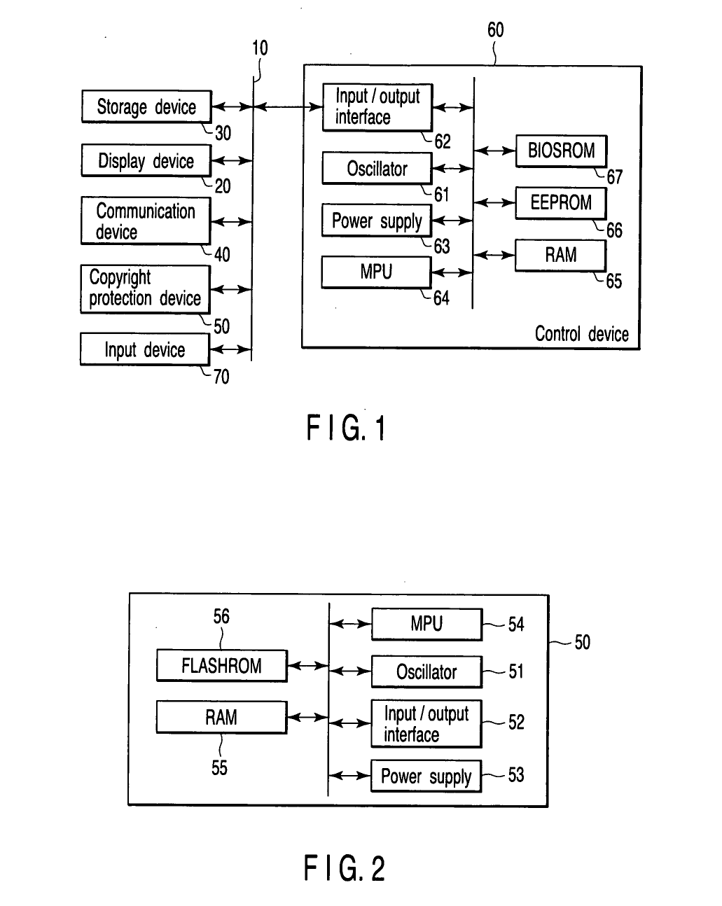

According to an embodiment, as shown in FIG. 1, an information processing apparatus, such as a personal computer, includes a PCI bus 10 that is a user access bus. A display device 20, a storage device 30, a communication device 40, a copyright protection device 50, a control device 60, and an input device 70 are connected to the PCI bus 10.

The display device 20 includes, for instance, a liquid crystal display, etc., configured to display necessary information. The input device 70 includes a keyboard, a pointing device, etc., configured to input the necessary information and various kinds of instructions. The storage device 30 includes a fixed storage medium, such as a hard disk, and furthermore, it may include a detachable storage medium, such as a DVD-RAM and a memory card. The communication device 40 communicates with external equipment though an Ethernet® communication function. Undoubtedly, the communication is not limited to a wired communication, and it may be made by wireless. The copyright protection device 50 has a function to encrypt and output data.

The control device 60 controls the information processing apparatus. The control device 60 is provided in, for example, a mother board form. The control device 60 includes an oscillator 61, an input/output interface 62, a power supply 63, a system memory, and an MPU 64. The oscillator 61 is used for setting a system time and for acquiring synchronization. The input/output interface 62 has a function to perform information exchange for the outside of the control device 60. The power supply 63 has a function of supplying power to each part in the control device 60. The system memory includes a RAM 65, an EEPROM 66, a BIOSROM 67, etc. The MPU 64 executes a program by using the RAM 65 to control the entire of the information processing apparatus.

The copyright protection device 50 includes, as shown in FIG. 2, an oscillator 51, an input/output interface 52, a power supply 53, a system memory, and an MPU 54. The oscillator 51 is used in order to acquire synchronization. The input/output interface 52 has a function to perform information exchange for the outside of the copyright protection device 50. The power supply 53 has a function to supply power to each part in the copyright protection device 50. The system memory includes a RAM 55, a FLASHROM 56, etc. The MPU 54 executes the program by using the RAM 55 to control the entire of the copyright protection device 50 as well as the communication function.

The copyright protection device 50, not depicted specifically, is provided, for example, in a form to function as a tuner in order to receive a terrestrial digital broadcasting. The copyright protection device 50 encrypts the vide data received and encoded to transfer it from the interface 52 to the control device 60 via the PCI bus 10. After decryption by a software decoder executed through the MPU 64 of the control device 60, the encrypted video data is decoded and may be reproduction-displayed on the display device 20. In this case, the software decoder reads out an encryption key parameter, which is stored in the copyright protection device 50 and described in detail below, by the input/output interface 62 via the PCI bus 10 from the copyright protection device 50. The software decoder generates an encryption key on the basis of the read out encryption key parameter to decrypt the encrypted video data by using the generated encryption key. The software recorder executed by the MPU 64 may record the encrypted video data in the recording device 30 such as a hard disk. The software decoder may decrypt and decode the recorded video data similarly in the case for video stream data from the copyright protection device 50.

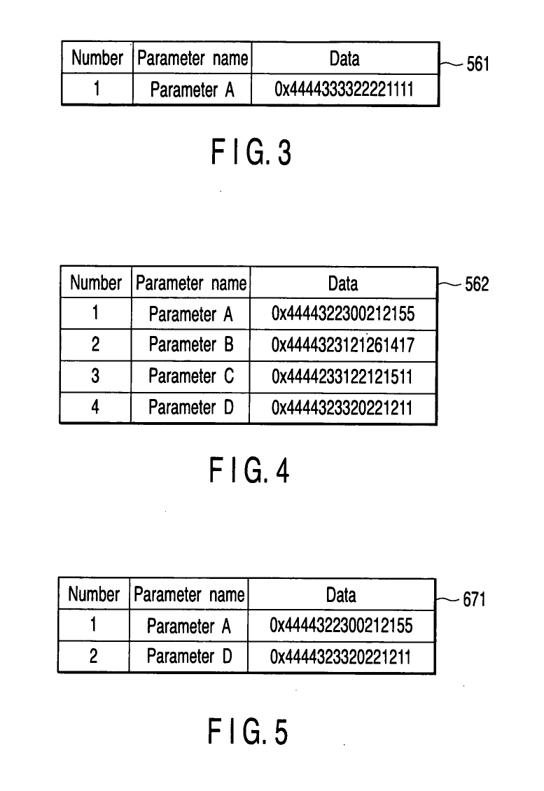

A parameter encryption key table 561 as shown in FIG. 3 is stored in the FLASHROM 56 of the copyright protection device 50. The encryption key table 561 includes a number item, a parameter name item corresponding thereto, and a data item of 8-bite length. The data item value “0x4444333322221111” is the same value for every copyright protection device 50.

A parameter table 562 managed by the copyright protection device 50 as shown in FIG. 4 is stored in the FLASHROM 56 of the copyright protection device 50. The parameter table 562 includes number items, parameter name items corresponding thereto, and data items of 8-byte lengths. The parameters to be stored in the parameter table 562 are ones to calculate encryption key parameters which become a source of the encryption key. In this case, the parameters are not stored as row parameter values, but stored as values which are encrypted by, for example, exclusive OR between the parameter and the data item value “0x444333322221111” stored in the encryption key table 561. That is, the data item value “0x0000110220330440” is stored as “0x444322300212155” by exclusive OR between “0x0000110220330440” and “0x444333322221111” in the data item of the parameter A. Similarly, “0x000001003040506”, “0x0000100200300400”, and “0x0000010002000300” are stored in the data items of the parameters B, C and D as “0x444323121261417”, “0x444233122121511” and “0x444323320221211” by exclusive OR between “0x444333322221111”, respectively. The data item values A and D to be stored in the parameter table 562 are values differing from those of each copyright protection device 50 (dynamic parameter), and the data item values B and C are the identical values for every copyright protection device 50 (static parameter).

On the other hand, a parameter table 671 managed by the control device 60 as shown in FIG. 5 is stored in the BIOSROM 67 of the control device 60. The parameter table 671 includes number items, parameter name items corresponding thereto, and data items of 8-byte lengths. In the way described below, the control device 60 copies the data item values stored at the item numbers 1 and 4 in the parameter table 562 managed by the copyright protection device 50 to the item number 1 and 2 of the parameter table 671, and stores them, respectively.

Hereinafter, operations of the information processing apparatus with such a configuration will be described.

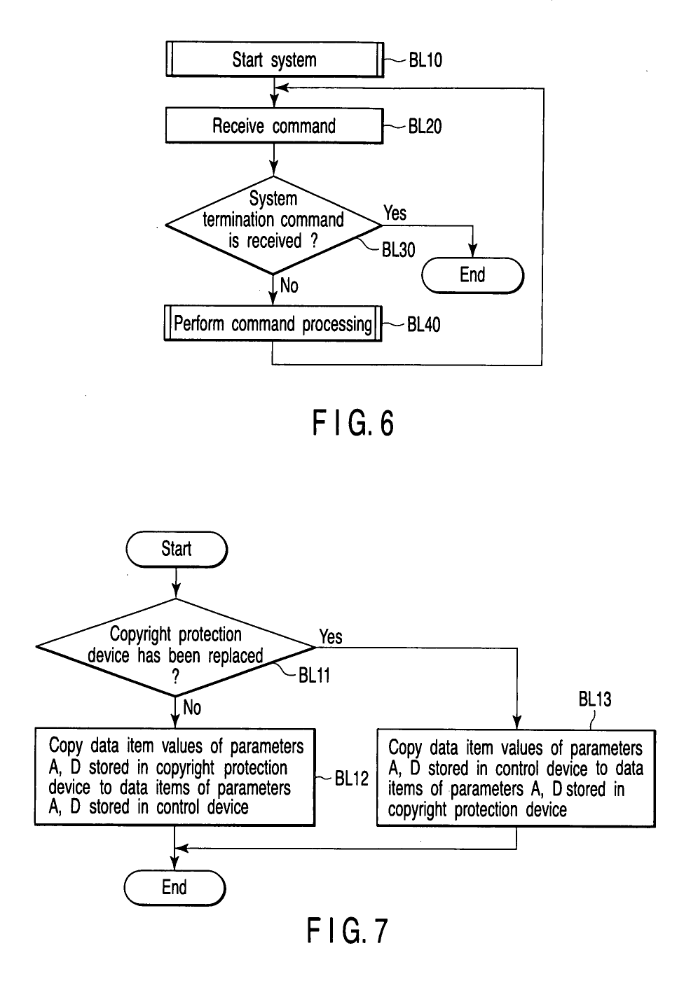

When the software decoder is started by the MPU 64 of the control device 60, with the start of the software decoder, the system start processing is, as shown in FIG. 6, carried out between the control device 60 and the copyright protection device 50 (block BL10). The system start processing will be described in detail later. After this, the software decoder sends commands to the copyright protection device 50 arbitrarily. At every reception of the command (block BL20), the MPU 54 of the copyright protection device 50 determines whether or not the command is a system termination command (block BL30). If the received command is a command other than the system termination command, the information processing apparatus carries out command processing in response to the command (block BL40). If the command is the system termination command to be transmitted at the termination time of the software decoder, the information processing apparatus ends its operations.

Not depicted specifically, but if the copyright protection device 50 and the control device 60 operate normally on starting the system, the data item values to be stored in the parameter table 562 are developed from the FLASHROM 56 to the RAM 55 of the copyright protection device 50. At this moment, the data item values to be developed to the RAM 55 are decrypted ones. The data item values “0x0000110220330440”, “0x0000010203040506”, “0x00001000200300400” and “0x0000010002000300” have been stored at the data items of the parameters A, B, C and D, respectively.

In the system start processing carried out in the block BL10, as shown in FIG. 7, at first, the copyright protection device 50 determines whether or not the copyright protection device 50 is one which has been replaced regarding the information processing apparatus (block BL11).

The determination is performed by, for example, preparing a maintenance application to be executed by a part of the software decoder, or by the MPU 64 of the control device 60 and by the instruction from the maintenance application. In such a case, a user instructs to the maintenance application, and the MPU 64 of the control device 60 does not determine automatically. That is, when the user replaces the copyright protection device 50, the system start processing initiates the maintenance application to issue an instruction from an input device 70.

On the contrary, preparing the maintenance application carried out at the MPU 54 of the copyright protection device 50, and determining the replacement depending on the instruction from the maintenance application is a possible approach. In this case, the maintenance application being initiated when the copyright protection device 50 is replaced, the system start processing may detect the replacement of the copyright protection device 50 by the instruction from the maintenance application.

Or, the copyright protection device 50 has a value, such as a MAC address, proper to the copyright protection device 50 and possible to determine the device itself, copies the MAC address to the BIOSROM 67 and the EEPROM 66 of the control device 60 to store it also on the side of the control device 60, and when the MPU 64 of the control device 60 conducts authentication processing of the MAC address to and from the copyright protection device 50, then, the system start processing determines the replacement of the copyright protection device 50.

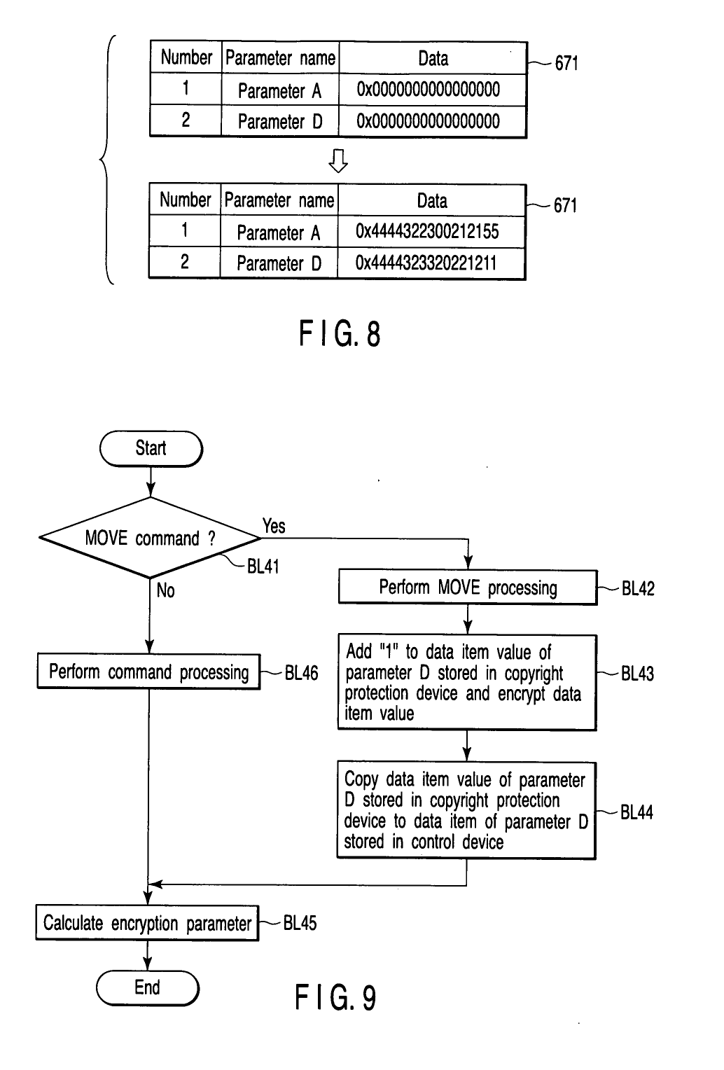

Here, if the MAC addresses are the same as each other, the system start processing determines that the copyright protection device 50 has not been replaced. If the MAC addresses are different from each other, the start processing determines which copyright protection device 50 has been replaced in accordance with the content of the parameter table 671 stored in the BIOSROM 67 of the control device 60. In other words, in an initial state, the values of the data items in the parameter table 671 are set to the identical values for each byte, for instance, “0x0000000000000000” as shown on the upper side in FIG. 8. If the data item values are such values, it is determines that the copyright protection device 50 has not been replaced but the control device 60 has been replaced. If the data item values are different from each other, it may be determined that the copyright protection device 50 has been replaced.

In the case in which the copyright protection device 50 has not been replaced, the system start processing makes copies of the data item values of the parameters A and D in the parameter table 562 stored in the FLASHROM 56 of the copyright protection device 50 to the data items of the parameters A and D in the parameter table 671 stored in the BIOSROM 67 of the control device 60 via the input/output interface 52, the PCI bus 10 and the input/output interface 62 (block BL12).

Thereby, when the control device 60 is replaced the data item values of the parameters A and D in the parameter table 562 stored in the FLASHROM 56 of the copyright protection device 50 as depicted in FIG. 4 are copied to the items of the parameters A and D in the parameter table 671 stored in the BIOSROM 67 of the control device 60 as shown in FIG. 8. As a result, the two data item values “0x0000000000000000” are updated to “0x444322300212155” and “0x444323320221211”, respectively. Even when any one of the copyright protection device 50 and the control device 60 has not been replaced, the data item values of the parameters A and D in the parameter table 562 stored in the FLASHROM 56 of the copyright protection device 50 are copied into the parameter table 671 stored in the BIOSROM 67 of the control device 60 and they are resulted in update.

On the contrary, when the copyright protection device 50 is replaced one, the start processing copies the data item values of the parameters A and D in the parameter table 671 stored in the BIOSROM 67 of the control device 60 to the data items of the parameters A and D in the parameter table 562 stored in the FLASHROM 56 of the copyright protection device 50 through the input/output interface 62, the PCI bus 10 and the input/output interface 52 (block BL13).

That is to say, every time at normally starting, the start processing copies the parameters from the copyright protection device 50 to the control device 60. Only when the replacement of the copyright protection devices 50 is detected through the maintenance application, etc., a copy operation of the parameter, from the control device 60 to the copyright protection device 50, which is the reverse processing in comparison to the processing automatically carried out usually, results in an execution.

In the command processing carried out in the block BL40, as illustrated in FIG. 9, at first, the MPU 54 of the copyright protection device 50 determines whether or not the received command is the MOVE command (block BL41). Here, the MOVE is processing defied by, for example, digital transmission content protection (DTCP), association of radio industries and businesses (ARIB), or the like. Namely, the MOVE means processing to move video data to other storage device 30, such as a DVD-RAM, from the storage device 30, such as a HDD. At this moment, it is needed to bring the video data, originally stored in the storage device 30 of the moving source, into disabling of reproduction. As for a method of disabling reproduction, a method for physically deleting the video data from the storage device 30 of the moving source is a possible approach. As to other method, in the case that the video data has been encrypted, a method for disabling the reproduction of the video data by deleting/changing the encryption key is also a possible approach. In the embodiment, this MOVE processing employs a method for changing the encryption key to disable the video data to be reproduced by updating the encryption parameter.

When receiving the MOVE command, the MPU 54 conducts the MOVE processing (block BL42). Here, when receiving the MOVE command, the encryption key parameter to encrypt content having been changed, re-encryption processing for the encrypted content is performed in use of the newly calculated encryption key parameter. Normal completion of the re-encryption processing updates the parameter on the FLASHROM 56 of the copyright protection device 50.

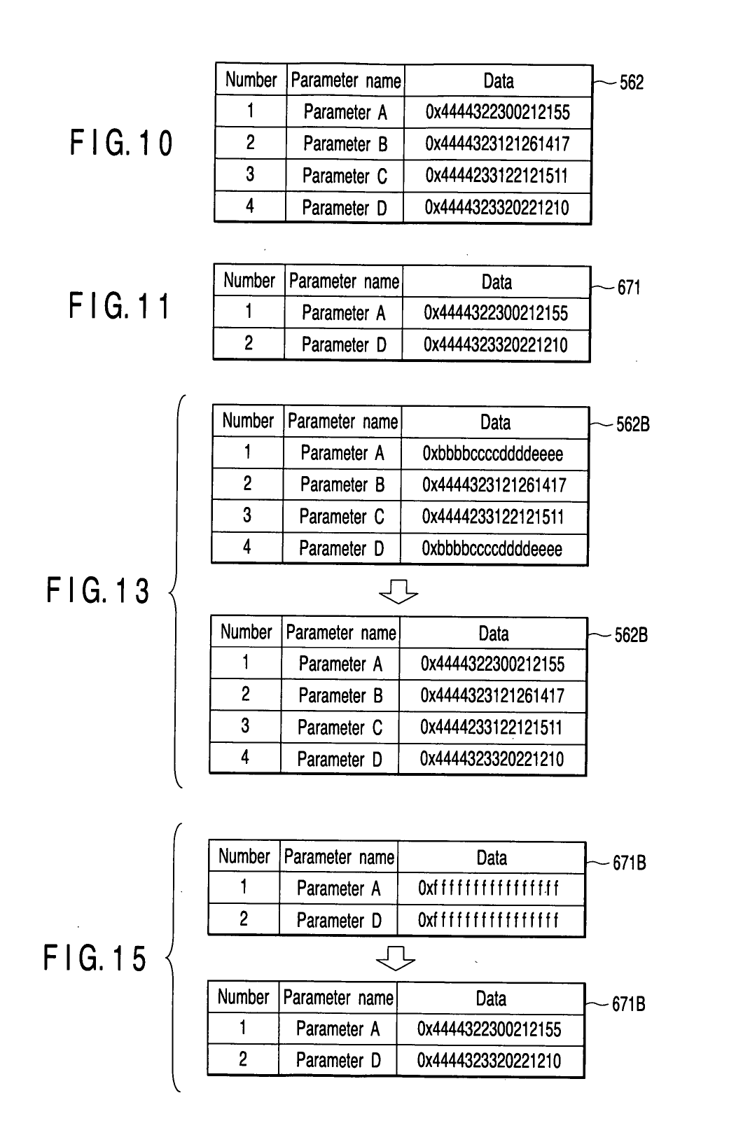

More specifically, in carrying out once the command processing, after the normal completion of the re-encryption processing of the data encrypted with the encryption parameter, the MOVE processing decrypts the data item value “0X4444323320221211” of the parameter D in the parameter table 562 as shown in FIG. 4 by the data item value “0x444333322221111” stored in the parameter encryption key table 561 as shown in FIG. 3, and adds, for instance, “1” to the obtained data item value “0x0000010002000300” to convert it into a data item value “0x0000010002000301” (block BL43). After this, the command processing encrypts again the data item value by the data item value “0x444333322221111” stored in the parameter encryption key table 561 shown in FIG. 3 to make a data item value “0x444323320221210” to store it in the parameter table 562 as depicted in FIG. 10.

Next, the command processing copies the data item value “0x444323320221210” of the parameter D to be managed by the updated parameter table 562 to the data item of the parameter D in the parameter table 671 stored in the BIOSROM 67 of the control device 60 as shown in FIG. 5, then, updates the parameter table 671 to the one as depicted in FIG. 11 and manages the data item of the parameter D (block BL44).

Like this, every repeating of the MOVE processing updates the parameter table 562 of the copyright protection device 50 and the parameter table 671 of the control device 60.

Next to this, the command processing calculates the encryption parameter (block BL45). This calculation calculates the encryption key parameter to be a source of the encryption key to encrypt the video data through the copyright protection device 50 by the following formula. In an example of the following formula, the encryption key parameter is calculated by exclusive OR between the parameter A and the parameter C, and by OR of exclusive OR between the parameter B and the parameter D:

Encryption key parameter (64 bit)=[parameter A (64 bit) ⊕ parameter C (64 bit)] ∥ [parameter B (64 bit) ⊕ parameter D (64 bit)] where, “⊕” represents exclusive OR, and “∥” represents OR.

At this moment, the command processing, as shown in FIG. 10, decrypts the data item values stored in the updated parameter table 562 to calculate the encryption key parameter by suing the data item value “0x444333322221111” stored in the parameter encryption key table 561 of the copyright protection device 50. The formula to calculate the encryption key parameter by the data item value in the parameter table 562 shown in FIG. 10 is expressed below, and the encryption key parameter has a data item value of “0x0000010221070647”:
[0x0000110220330440 ⊕ 0x0000100200300400] ∥ [0x0000010203040506 ⊕ 0x0000010002000300]=0x0000010221070647

The copyright protection device 50 further creates an encryption key in the use of the encryption key parameter calculated in such a manner, encrypts the video data in the use of the encryption key, and outputs it to a software decoder which has been running on the MPU 64 of the control device 60 connected through the PCI bus 10.

The software decoder reads out the data item value stored in the parameter table 562 of the copyright protection device 50 to create an encryption key in the same way, and decrypts the encrypted video data which has been sent from the copyright protection device 50. The software decoder then decodes the decrypted video data to display it on the display device 20.

In the aforementioned command processing, if the MPU 54 of the copyright protection device 50 determines the reception of the command other than the MOVE command (block BL41), the command processing carries out the processing in response to the received command (block BL46). The command processing results in calculation of the encryption key parameter by using the data item value in the parameter table 562 which has been updated or has not been updated through the execution of the command (block BL45).

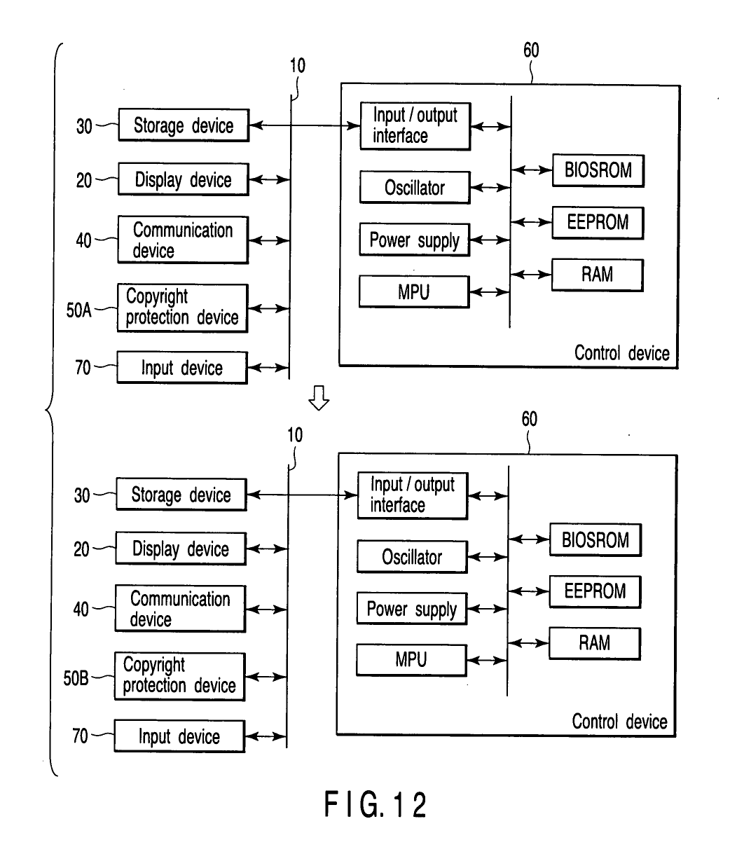

Next, as depicted in FIG. 12, in the case in which a certain copyright protection device 50A is replaced with another copyright protection device 50B in the information processing apparatus will be further described.

That is, when the copyright protection device 50A goes wrong due to some reason, the copyright protection device 50A is replaced for a new copyright protection device 50B. Here, the copyright protection devices 50A and 50B are the same in configuration. However, the FLASHROM 56 of the new copyright protection device 50B has stored, as shown in FIG. 3, the same content as that of the failed copyright protection device 50A concerning the parameter encryption key table 561, but as shown on the upper side of FIG. 13, the FLASHROM 56 has stored the data item values differing from those in the parameter table 562 of the copyright protection device 50A in relation to the parameter table 562B. In other words, data item values “0xbbbbccccddddeeee”, “0x444323121261417”, “0x44423311221121511”, and “0xbbbbccccddddeeee” are stored at the data items of the parameters A, B, C and D, respectively, in the parameter table 562B, as the data item values encrypted by exclusive OR with the data item value “0x4444333322221111” stored in the parameter encryption table 561. Like this, as to the data item values of the parameters B and C are the same because they are common to every copyright protection device; however as for the data item values of the parameters A and D are different from those of the copyright protection device 50A.

In such a case, in which the copyright protection devices are replaced, as described above, the copies of the parameters A and D are made in the block BL13 on starting the system. The data item value “0x4444322300212155” of the parameter A is copied from the parameter table 671 stored in the BIOSROM 67 of the control device 60 as illustrated in FIG. 11 to the data item of the parameter A in the parameter table 562B of the copyright protection device 50B. The data item value “0x444323320221210” of the parameter D is copied from the parameter table 671 as illustrated in FIG. 11 to the data item of the parameter D in the parameter table 562B of the copyright protection device 50B. The data item value of the parameter D is resulted in storage in the FLASH ROM 56 as the parameter table 562B as depicted on the lower side of FIG. 13.

Thus, copying the data item values in the parameter table 671 managed by the control device 60 into the parameter table 562B managed by the copyright protection device 50B results in enabling of the calculation of the encryption key parameter which has been stored in the faulty copyright protection device 50A by using the data item values stored in the parameter table 562B of the copyright protection device 50B and the data item values stored in the parameter encryption key table 561. Also the software decoder carried out in the MPU 64 of the control device 60 can calculate the encryption key parameter by using the data item values stored in the parameter table 562B of the copyright protection device 50B, and it can decrypt the video data encrypted through the copyright protection device 50A prior to replacement.

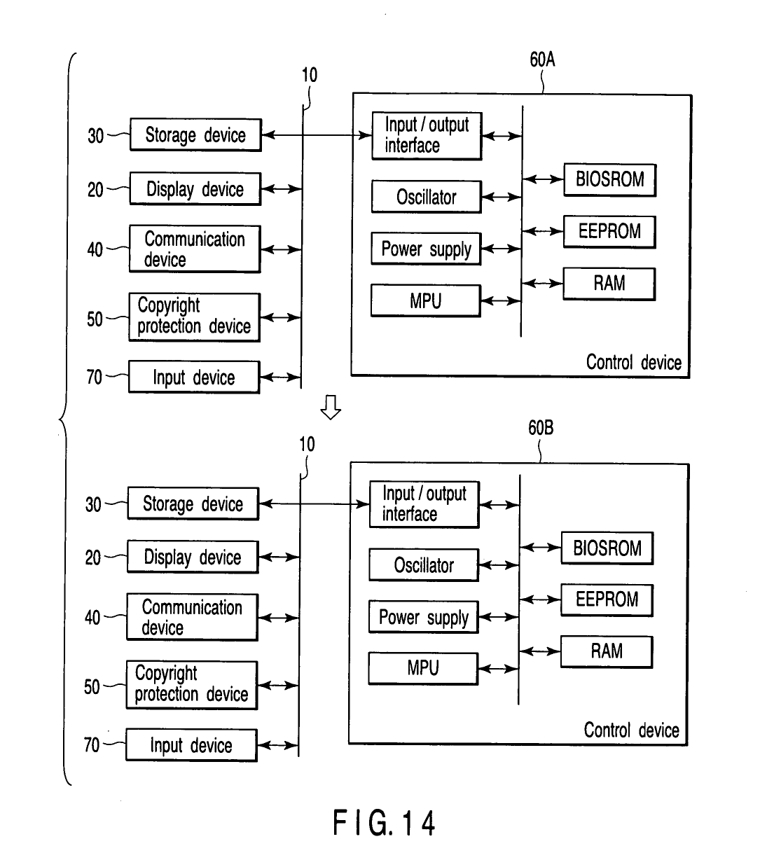

Further, as shown in FIG. 14, the case in which a certain control device 60A is replaced with another control device 60B will be described. Here, the replacement of the control device means not only the case in which the whole of the control device is replaced but also the case in which only the BIOSROM 67 is repaired or replaced.

That is to say, when the control device 60A goes wrong due to some reason, the control device 60A is replaced with a new control device 60B. Here, the control device 60A and the control device 60B are the same in configuration. However, in the BIOSROM 67 of the control device 60B, the data item value of the parameter table 671B is initialized by the identical values for each byte, for example, the data item value “0xffffffffffffffff” as indicated on the upper side in FIG. 15.

Like this, when the control device is replaced, on starting the system, as mentioned above, the copies of the parameters A and D are made in the block BL12. The copy of the data item value“0x4444322300212155” of the parameter A in the parameter table 562 stored in the FLASHROM 56 of the copyright protection device 50 as shown in FIG. 10 is made to the data item of the parameter A in the parameter table 671B stored in the BIOSROM 67 of the control device 60B. The copy of the data item value “0x444323320221210” of the parameter data D is made from the parameter table 562 as similarly shown in FIG. 10 to the data item of the parameter D in the parameter table 671B of the control device 60B. The data item value of the parameter D results in storing, as the parameter table 671B as indicated on the lower side in FIG. 15, in the BIOSROM 67.

Thus, the information processing apparatus makes the copies of the data item values in the parameter table 562 managed by the copyright protection device 50 into the parameter table 671B managed by the control device 60B. The copyright protection device 50 calculates the encryption key parameter in use of the data item value stored in the parameter table 562 of the copyright protection device 50 and the data item values stored in the parameter encryption key table 561, and generates the encryption key by using the calculated encryption parameter to encrypt the video data. Also the software decoder executed in the MPU 64 of the replaced control device 60B may calculate the encryption key parameter in use of the data item values stored in the parameter table 562 of the copyright protection device 50, and may decrypt the video data encrypted by the copyright protection device 50.

As given above, having described the present invention on the basis of one embodiment thereof, the invention is not limited to the embodiment, and needless to say, various modifications and applications may be made without departing from the spirit or scope of the general inventive concept.

For instance, in the foregoing embodiment, the data item values in the parameter table 562 managed by the FLASHROM 56 of the copyright protection device 50, and the data item values in the parameter table 671 managed by the BIOSROM 67 of the control device 60 having been indicated with numerical values of 8-byte, respectively, other figures other than those indicated here may be usable.

In the aforementioned embodiment, the parameters copied from the copyright protection device 50 being stored in the BIOS ROM 67 of the control device 60, they may be stored in a nonvolatile storage device, such as a hard disk.

Furthermore, a method for encrypting the parameter is also not limited to the method using the exclusive OR as described in the given embodiment. In the forgoing embodiment, the exclusive OR between the parameters A and B and the OR of the exclusive OR between the parameters C and D being set as the encryption key parameter, calculating the encryption key parameter through other calculation method is possible approach. Moreover, it is not necessary for the values and the numbers of the parameters to calculate the encryption parameter to be limited specially.

In the given embodiment, the parameter D having added value “1” to each MOVE processing, the information processing apparatus may manage the parameters in such a method in which the parameters are reduced for every MOVE processing, or the random numbers are generated for every MOVE processing.

The aforementioned embodiment having described by taking the case in which the invention is applied to the information processing apparatus of the personal computer, or the like, it is absolutely for the invention to be applied to any video processing apparatus as long as the copyright protection device 50 supplies the encrypted video data onto the user access bus. Further, the copyright protection device 50 having provided in a form to function as a tuner for the terrestrial digital broadcasting receiver, the copyright protection device 50 may be provided in a form of a tuner for other digital broadcasting, such as a broadcasting satellite (BS) digital broadcasting.

It is not needed to say for the present invention to be employed for not only the video data but also for any data in need of the copyright protection.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A copyright protection system comprising:
a processor configured to execute a variety of programs;
a bus which transfers a variety of items of data;
a copyright protection device which encrypts the data for transferring the data in need of copyright protection to the processor via the bus;
a copyright protection device nonvolatile memory which is provided in the copyright protection device to store, in non-volatile form, an encryption key parameter to be a source of an encryption key to be used for a encryption by the copyright protection device;
a nonvolatile memory which is connected to the copyright protection device via the bus and stores, in non-volatile form, the encryption key parameter stored in the copyright protection device nonvolatile memory; and
a decryption unit which is composed of software to be executed by the processor, wherein the decryption unit generates the encryption key on the basis of the encryption key parameter stored in the copyright protection device nonvolatile memory and makes the processor execute processing to decrypt the encrypted data, which is transferred from the copyright protection device via the bus, by using the generated encryption key.

2. The system according to claim 1, wherein
the encryption key parameter in the nonvolatile memory is updated on the basis of the encryption key parameter to be changed at timing when the copyright protection device changes the encryption key parameter.

3. The system according to claim 2, wherein
the update includes making a copy.

4. The system according to claim 1, wherein
it is confirmed whether or not the copyright protection device is replaced on starting the copyright protection system, and if it is not replaced, the encryption key parameter in the nonvolatile memory is updated on the basis of the encryption key parameter stored in the copyright protection device nonvolatile memory.

5. The system according to claim 4, further comprising:
a user input unit which confirms whether or not the copyright protection device is replaced.

6. The system according to claim 4, wherein
the copyright protection device includes specific information to specify the copyright protection device itself, and
the system further comprises:
a specific information storage unit which stores the specific information of the copyright protection device; and
a confirmation unit which compares the specific information stored in the storage unit to specific information owned by the copyright protection device to confirm whether or not the copyright protection device is replaced.

7. The system according to claim 4, wherein
the update includes making a copy.

8. The system according to claim 1, wherein
it is confirmed whether or not the copyright protection device is replaced on starting the copyright protection system, and if it is replaced, the encryption key parameter stored in the copyright protection device nonvolatile memory is updated on the basis of the encryption key parameter stored in the nonvolatile memory.

9. The system according to claim 8, further comprising:
a user input unit which confirms whether or not the copyright protection device is replaced.

10. The system according to claim 8, wherein
the copyright protection device includes specific information to specify the copyright protection device itself, and
the system further comprises:
a specific information storage unit which stores the specific information of the copyright protection device; and
a confirmation unit which compares the specific information stored in the storage unit to specific information owned by the copyright protection device to confirm whether or not the copyright protection device is replaced.

11. The system according to claim 8, wherein
the update includes making a copy.

12. A copyright protection device which encrypts data in need of copyright protection to output it comprising:
a copyright protection device nonvolatile memory which stores, in non-volatile form, an encryption parameter to be a source of an encryption key when the data is encrypted; and
a storage control unit which stores the encryption key parameter stored in the copyright protection device nonvolatile memory to an external nonvolatile memory on starting.

13. The device according to claim 12, wherein
the encryption key parameter stored in the copyright protection device nonvolatile memory is updated on the basis of the encryption key parameter stored on the external nonvolatile memory in accordance with an instruction form the outside.

14. A video processing apparatus comprising:
a processor configured to execute a variety of programs;
a bus which transfers a variety of items of data;
a copyright protection device which encrypts video data for transferring compression-encoded video data in need of copyright protection to the processor via the bus;
a decoder which is composed of software to be executed by the processor, wherein the decoder decodes the encrypted video data transferred from the copyright protection device via the bus and then makes the processor execute processing to decode the video;
a copyright protection device nonvolatile memory which is provided in the copyright protection device to store, in non-volatile form, an encryption key parameter to be a source of an encryption key to be used for a encryption of the video data by the copyright protection device; and
a nonvolatile memory which store, in nonvolatile form, a static parameter and a dynamic parameter to calculate the encryption parameter.
